(19) United States
(12) Patent Application Publication
(10) Pub. No.: US 2025/0195317 A1
(43) Pub. Date: Jun. 19, 2025

(54) ATTACHABLE LEG MASSAGER FOR CHAIR

(71) Applicant: Zhejiang Qikai Electromechanical Technology Co., Ltd., Huzhou City (CN)

(72) Inventor: Dong-Her Wu, Changhua (TW)

(21) Appl. No.: 18/733,711

(22) Filed: Jun. 4, 2024

(30) Foreign Application Priority Data
Dec. 15, 2023 (TW) 112149384

(51) Int. Cl. A61H 15/00; A47C 9/00

(52) U.S. Cl. CPC A61H 15/0078; A47C 9/002; A61H 2201/0149; A61H 2201/0161; A61H 2201/1676; A61H 2203/0431; A61H 2205/10

(57) ABSTRACT

An attachable leg massager for chair may include a leg massager and a chair. The leg massager has a fixed base which is connected to the bottom of the chair, and the fixed base comprises a power source and a pivot base. A massaging member has a pivot frame at the bottom thereof, and a massage motor is installed in the massaging member, and each of two lateral sides of the massage motor is connected to a massage wheel. The pivot frame is pivotally connected to the pivot base, and a power motor is installed in the power source. Each of two lateral sides of the power motor is connected to a rocker arm, and the rocker arm is pivotally connected to a push-pull rod, and the push-pull rod is pivotally connected to the pivot frame.

### FIELD OF THE INVENTION

The present invention relates to a leg massager and more particularly to an attachable leg massager for chair that features smooth and stable mechanical motion.

### BACKGROUND OF THE INVENTION

Referring to FIGS. 9 and 10, a conventional leg massager comprises a base (70), a massaging member (80), and a chair (90). The base (70) is fixed on the bottom of the chair (90), and the massaging member (80) has a power source (81) installed therein to drive a crank (82) and a connecting rod (83). The connecting rod (83) is pivotally connected to the base (70), and the user is adapted to sit on the chair (90). The massaging member (80) is cooperated with the crank (82) and the connecting rod (83) to drive the massaging member (80) to massage the user's legs.

However, the conventional leg massager has following disadvantages: the massaging member (80) is only supported by the crank (82) and the connecting rod (83), and the power source (81) is located in the massaging member (80) so as to raise the center of gravity of the structure. Thus, when the weight of the user's leg is applied to the massaging member (80), the power source (81) has to counteract gravity during operation, which may cause the crack (82) and the connecting rod (83) to fail in performing proper mechanical motion, and then result in the massaging member (80) moving unevenly and lowering the massage effect. Therefore, there remains a need for a new and improved design for an attachable leg massager for chair to overcome the problems presented above.

### SUMMARY OF THE INVENTION

The present invention provides an attachable leg massager for chair comprising a leg massager and a chair. The leg massager has a fixed base which is connected to the bottom of the chair, and the fixed base comprises a power source and a pivot base. A massaging member has a pivot frame at the bottom thereof, and a massage motor is installed in the massaging member, and each of two lateral sides of the massage motor is connected to a massage wheel. The pivot frame is pivotally connected to the pivot base, and a power motor is installed in the power source. Each of two lateral sides of the power motor is connected to a rocker arm, and the rocker arm is pivotally connected to a push-pull rod, and the push-pull rod is pivotally connected to the pivot frame. When in use, the user sits on the chair and leans the inner sides of legs on the massage wheels. The power motor is adapted to drive and rotate the rocker arms, and the rocker arms drive the push-pull rods to push and pull the pivot frame, so that the massaging member swings back and forth, and the massage wheels press the inner sides of legs to achieve the massage effect.

In one embodiment, the leg massager has the massaging member protruding from the front side of the chair, and other portions are located under the chair.

In another embodiment, the chair is a folding chair.

Comparing with conventional leg massager, the present invention is advantageous because: (i) the power source is fixed on the fixed base, and the massaging member is pivotally connected on the pivot base, so that the weight of legs is distributed on the leg massager and the center of gravity of structure is more stable; and (ii) the power source is fixed on the fixed base, and the massaging member is pivotally installed on the pivot base, so that the power motor, together with the rocker arms and the push-pull rods, are adapted to push and pull and pivotally rotate the massaging member in a relatively horizontal direction, which also makes the movement of the mechanism more stable, even if heavy weight borne on the massaging member not affects the operation of the leg massager.

### BRIEF DESCRIPTION OF THE DRAWINGS

FIG. 1 is a three-dimensional assembly view of an attachable leg massager for chair of the present invention.

FIG. 2 is an exploded view of a leg massager of the attachable leg massager for chair of the present invention.

FIG. 3 is a top view of the attachable leg massager for chair of the present invention when in use.

FIG. 4 is a schematic view illustrating the initial position of a massaging member of the attachable leg massager for chair of the present invention.

FIG. 5 is a schematic view illustrating the massaging member of the attachable leg massager for chair of the present invention is pushed forward.

FIG. 6 is a schematic view illustrating the massaging member of the attachable leg massager for chair of the present invention is pulled back.

FIG. 7 is a schematic view of a second embodiment of the attachable leg massager for chair of the present invention.

FIG. 8 is a three-dimensional view of a third embodiment of the attachable leg massager for chair of the present invention.

FIG. 9 is a prior art.

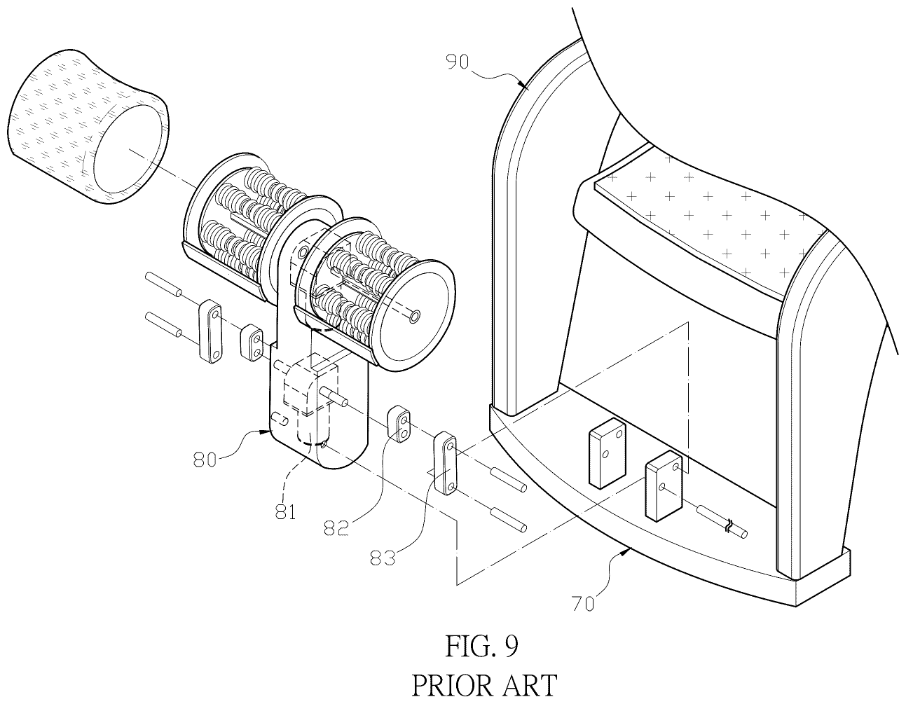

FIG. 10 is a prior art.

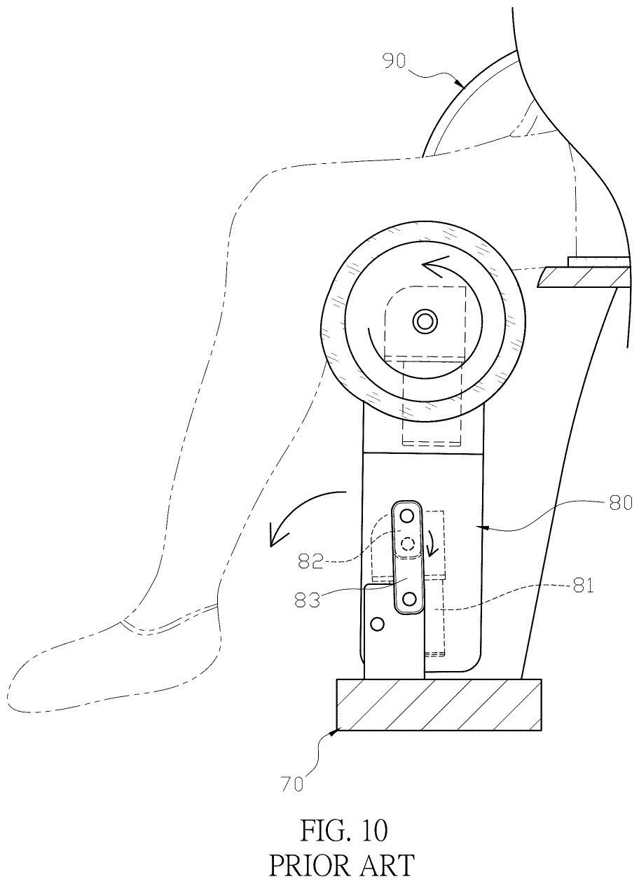

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

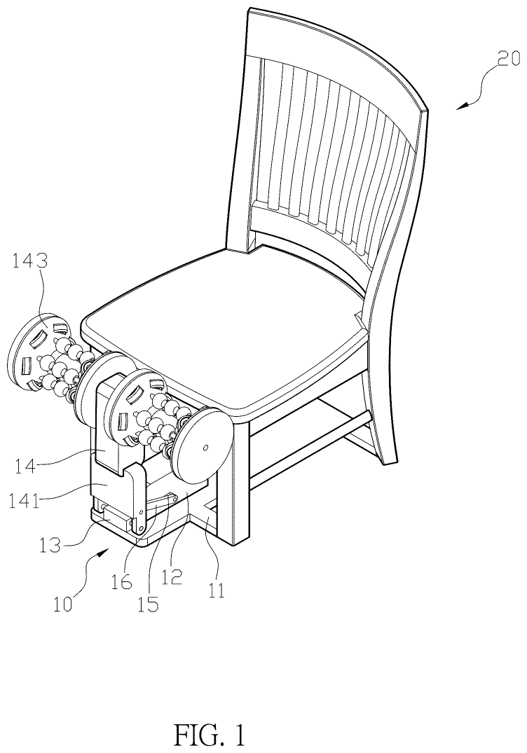

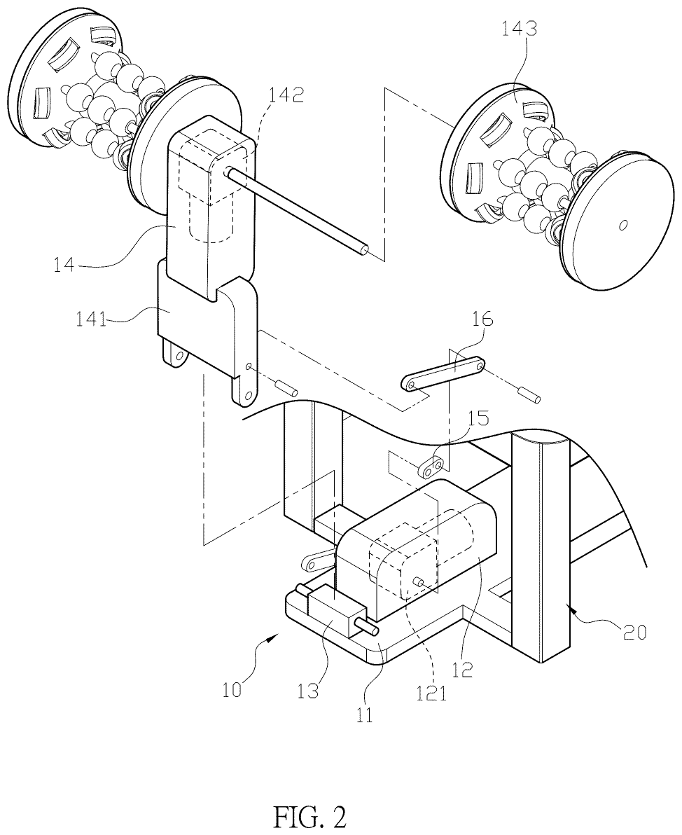

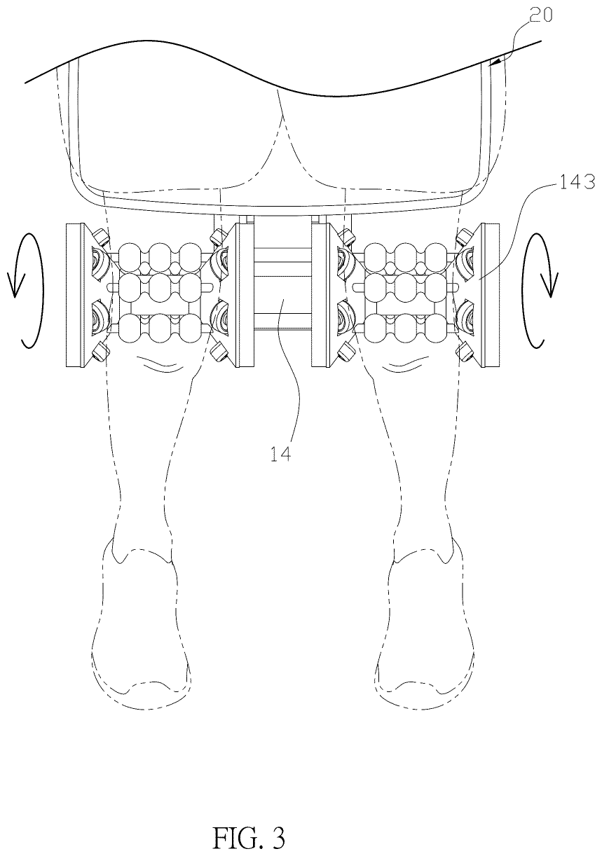

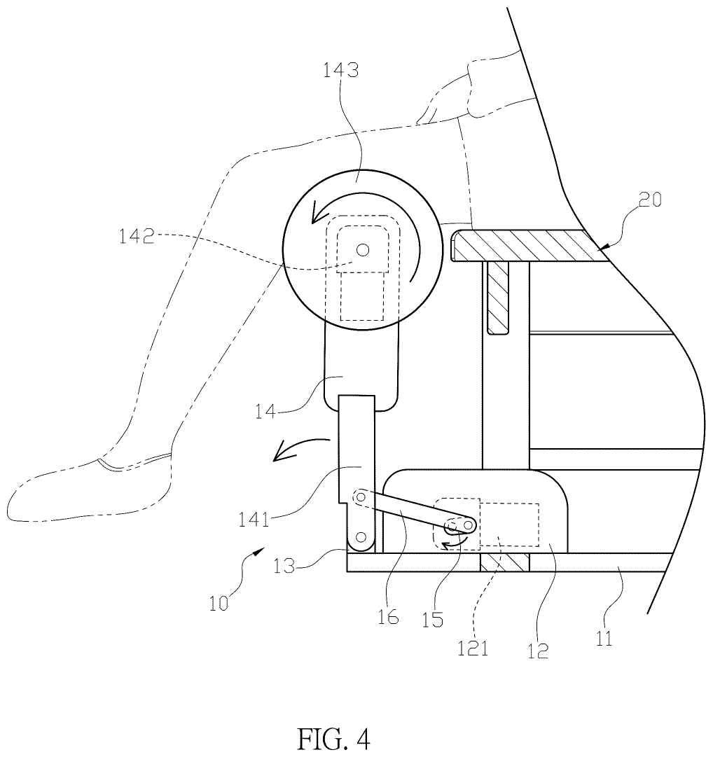

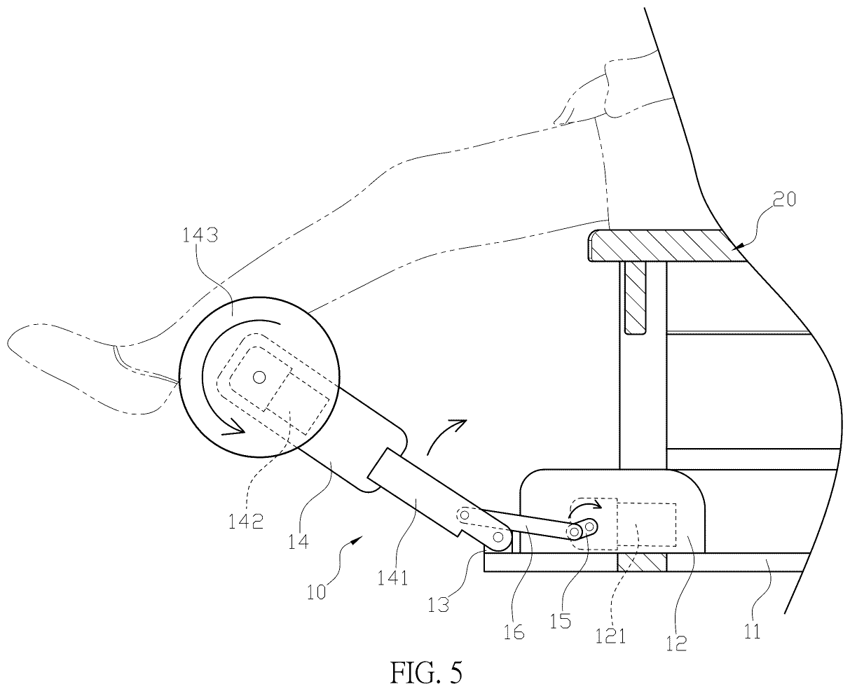

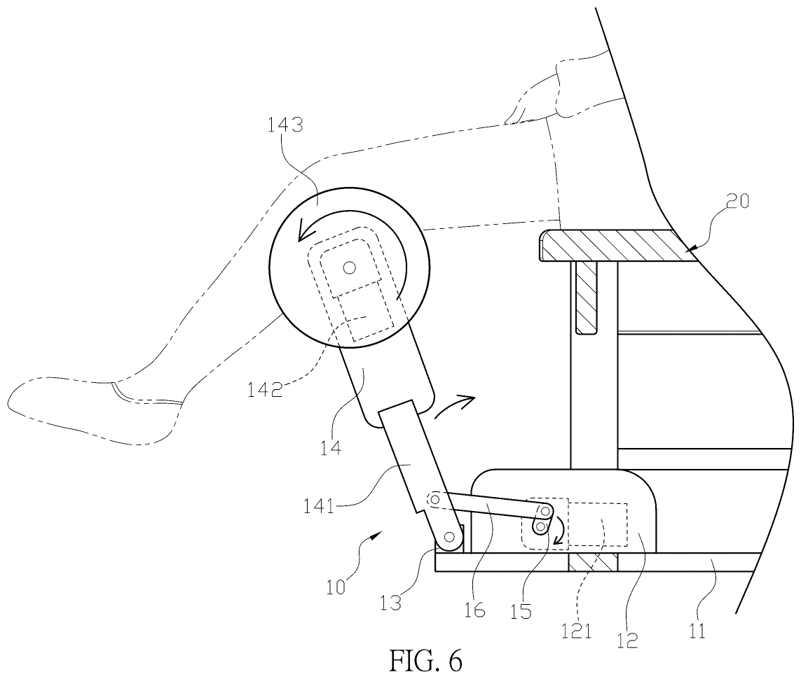

Referring to FIGS. 1 to 3, the present invention provides an attachable leg massager for chair comprising a leg massager (10) and a chair (20). The leg massager (10) has a fixed base (11) which is connected to the bottom of the chair (20), and the fixed base (11) comprises a power source (12) and a pivot base (13). A massaging member (14) has a pivot frame (141) at the bottom thereof, and a massage motor (142) is installed in the massaging member (14), and each of two lateral sides of the massage motor (142) is connected to a massage wheel (143). Moreover, the pivot frame (141) is pivotally connected to the pivot base (13), and a power motor (121) is installed in the power source (12). In addition, each of two lateral sides of the power motor (121) is connected to a rocker arm (15), and the rocker arm (15) is pivotally connected to a push-pull rod (16), and the push-pull rod (16) is pivotally connected to the pivot frame (141). Referring to FIGS. 4 to 6, in actual application, the user sits on the chair (20) and leans the inner sides of legs on the massage wheels (143). The power motor (121) is adapted to drive and rotate the rocker arms (15), and the rocker arms (15) drive the push-pull rods (16) to push and pull the pivot frame (141), so that the massaging member (14) swings back and forth, and the massage wheels (143) press the inner sides of legs to achieve the massage effect.

The power source (12) is fixed on the fixed base (11), and the massaging member (14) is pivotally connected on the pivot base (13), so that the weight of legs is distributed on the leg massager and the center of gravity of structure is more stable. Also, the mechanism movement is more stable when the power motor (121) pushes and pulls the massaging member (14) to swing back and forth, and when the user sits on the chair (20), the center of gravity of the leg massager (10) is configured to be further stabilized, so as to improve the stability of the leg massager (10) when used.

Referring to FIGS. 4 to 6, when the massaging member (14) is at the initial position and the power motor (121) drives and rotates the rocker arms (15), the rocker arms (15) are rotated to push the push-pull rods (16) so as to push the pivot frame (141), and the massaging member (14) is pivotally pushed forward. When the rocker arms (15) are rotated to pull the push-pull rods (16) so as to pull the pivot frame (141), and the massaging member (14) is pivotally pulled back. The pivoting process of the massaging member (14) conforms to the shape of the user's legs that are naturally dropped when sitting down, and the massage wheels (143) are adapted to be moved up and down to completely massage the inner sides of legs.

The power source (12) is fixed on the fixed base (11), and the massaging member (14) is pivotally installed on the pivot base (13), so that the power motor (121), together with the rocker arms (15) and the push-pull rods (16), are adapted to push and pull and pivotally rotate the massaging member (14) in a relatively horizontal direction, which also makes the movement of the mechanism more stable, even if heavy weight borne on the massaging member (14) not affects the operation of the leg massager (10).

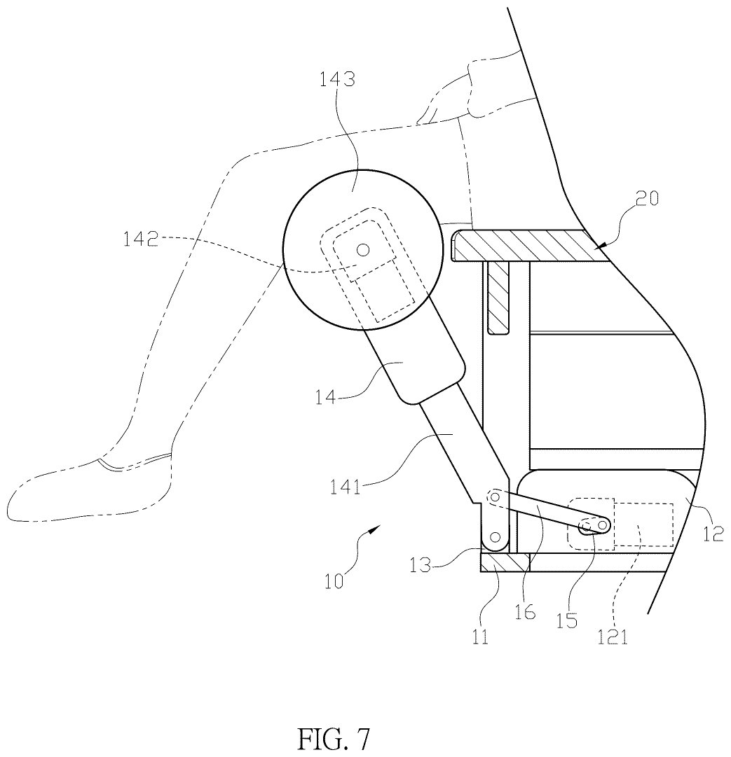

Referring to FIG. 7, in another embodiment, the leg massager (10) has only the massaging member (14) protruding from the front side of the chair (20) and other portions are located under the chair (20), so as to prevent the user's hair and trousers from being entangled in the leg massager (10) due to the mechanical movement and causing danger.

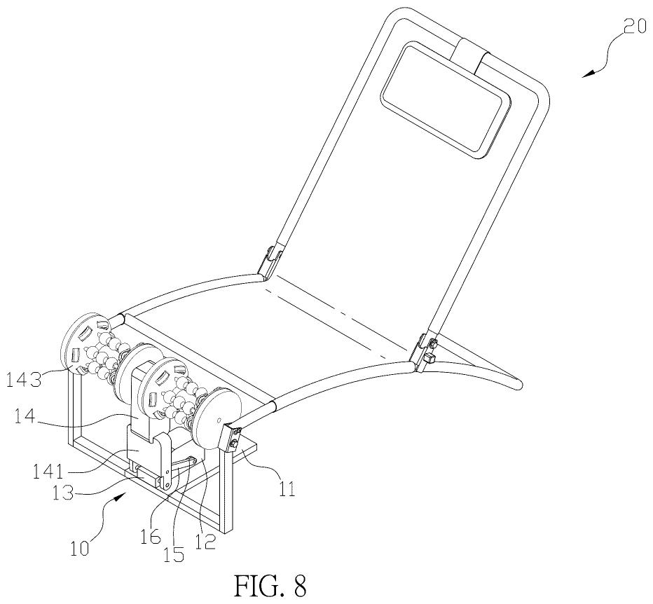

Referring to FIG. 8, in still another embodiment, the chair (20) is a folding chair.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An attachable leg massager for chair comprising a leg massager and a chair;
wherein the leg massager has a fixed base which is connected to the bottom of the chair, and the fixed base comprises a power source and a pivot base; a massaging member has a pivot frame at the bottom thereof, and a massage motor is installed in the massaging member, and each of two lateral sides of the massage motor is connected to a massage wheel; the pivot frame is pivotally connected to the pivot base, and a power motor is installed in the power source; each of two lateral sides of the power motor is connected to a rocker arm, and the rocker arm is pivotally connected to a push-pull rod, and the push-pull rod is pivotally connected to the pivot frame; when in use, the user sits on the chair and leans the inner sides of legs on the massage wheels; the power motor is adapted to drive and rotate the rocker arms, and the rocker arms drive the push-pull rods to push and pull the pivot frame, so that the massaging member swings back and forth, and the massage wheels press the inner sides of legs to achieve the massage effect.

2. The attachable leg massager for chair of claim 1, wherein the leg massager has the massaging member protruding from the front side of the chair, and other portions are located under the chair.

3. The attachable leg massager for chair of claim 1, wherein the chair is a folding chair.
